(19) United States
(12) Patent Application Publication
(10) Pub. No.: US 2026/0322620 A1
(43) Pub. Date: Oct. 15, 2026

(54) IDENTIFICATION AND AUTHORIZATION USING WRAPPED TOKENS AND PUBLIC/PRIVATE CRYPTOGRAPHIC KEYS

(71) Applicant: Goldman Sachs & Co. LLC, New York, NY (US)

(72) Inventors: Stefano Stefani, Issaquah, WA (US); Dheepak Ramanujam, Jersey City, NJ (US); Jonathan Edward Perry, London (GB)

(21) Appl. No.: 19/425,578

(22) Filed: Dec. 18, 2025

Related U.S. Application Data
(60) Provisional application No. 63/789,290, filed on Apr. 15, 2025.

(51) Int. Cl. H04L 9/32

(52) U.S. Cl. CPC H04L 9/3247; H04L 9/3263

(57) ABSTRACT

A method includes receiving, by a specified service in a series of services, a first token associated with an entity. The method also includes using a digital signature of the first token to identify the entity as providing the first token and to authorize the entity. The method further includes generating a second token that includes the first token, where the second token is digitally signed using a private key of the specified service. In addition, the method includes communicating the second token to a subsequent service in the series, where the subsequent service is configured to use a digital signature of the second token to identify the specified service as providing the second token and to authorize the specified service.

### CROSS-REFERENCE TO RELATED APPLICATION AND PRIORITY CLAIM

This application claims priority under 35 U.S.C. § 119 (e) to U.S. Provisional Patent Application No. 63/789,290 filed on Apr. 15, 2025, which is hereby incorporated by reference in its entirety.

### TECHNICAL FIELD

This disclosure is generally directed to computing and networking security systems and processes. More specifically, this disclosure is directed to identification and authorization using wrapped tokens and public/private cryptographic keys.

### BACKGROUND

In conventional client-server architectures, it is a relatively simple task for a server to identify and authenticate a client or vice versa. Similarly, in other call chains involving only two entities, it is a relatively simple task for each entity to identify and authorize the other entity. Example techniques that may be used here include mutual Transport Layer Security (mTLS) techniques, bearer tokens, or digital signatures.

### SUMMARY

This disclosure relates to identification and authorization using wrapped tokens and public/private cryptographic keys.

In a first embodiment, a method includes receiving, by a specified service in a series of services, a first token associated with an entity. The method also includes using a digital signature of the first token to identify the entity as providing the first token and to authorize the entity. The method further includes generating a second token that includes the first token, where the second token is digitally signed using a private key of the specified service. In addition, the method includes communicating the second token to a subsequent service in the series, where the subsequent service is configured to use a digital signature of the second token to identify the specified service as providing the second token and to authorize the specified service.

Any single one or any combination of the following features may be used with the first embodiment. The entity may include a preceding service in the series, the digital signature of the first token may be based on a private key of the preceding service, and a public key of the preceding service may be used to verify the digital signature of the first token. The first token may include an additional token provided to the preceding service. Each service in the series may receive and process a respective token without requesting that an external component verify an identity. Each service in the series may obtain public keys of other services and use one or more of the public keys to process the respective token. Each service in the series may be configured with information identifying other services authorized to invoke that service, and each service in the series may process a respective token by determining whether a source of the respective token is authorized to invoke that service based on the information. The first token may include an identifier of the second service as the first service's next hop in the series, and the second token may include an identifier of the subsequent service as the second service's next hop in the series. Tokens associated with the series, including the first and second tokens, may be serialized such that each token except an initial token wraps all prior token or tokens in the series. A number of services in the series may be expandable to include any desired number of services. Each token may be associated with at least one authorized function and may not be used to invoke other functions. Each token may be associated with a defined time during which the token is valid.

In a second embodiment, an apparatus includes at least one processing device configured to receive, for a specified service in a series of services, a first token associated with an entity. The at least one processing device is also configured to use a digital signature of the first token to identify the entity as providing the first token and to authorize the entity. The at least one processing device is further configured to generate a second token that includes the first token, where the second token is digitally signed using a private key of the specified service. In addition, the at least one processing device is configured to initiate communication of the second token to a subsequent service in the series, where the subsequent service is configured to use a digital signature of the second token to identify the specified service as providing the second token and to authorize the specified service.

Any single one or any combination of the following features may be used with the second embodiment. The entity may include a preceding service in the series, the digital signature of the first token may be based on a private key of the preceding service, and a public key of the preceding service may be used to verify the digital signature of the first token. The first token may include an additional token provided to the preceding service. The first token may be received and processed without requesting that an external component verify an identity. The specified service may obtain public keys of other services and use one or more of the public keys to process tokens from the other services. The specified service may be configured with information identifying other services authorized to invoke the specified service, and the first token may be processed to determine whether a source of the first token is authorized to invoke the specified service based on the information. The first token may include an identifier of the second service as the first service's next hop in the series, and the second token may include an identifier of the subsequent service as the second service's next hop in the series. The second token may wrap all prior token or tokens generated by one or more preceding services in the series. A number of services in the series may be expandable to include any desired number of services. At least one of the first and second tokens may be associated with at least one authorized function and may not be used to invoke other functions. At least one of the first and second tokens may be associated with a defined time during which that token is valid.

In a third embodiment, a non-transitory computer readable medium contains instructions that when executed cause at least one processor to receive, for a specified service in a series of services, a first token associated with an entity. The non-transitory computer readable medium also contains instructions that when executed cause the at least one processor to use a digital signature of the first token to identify the entity as providing the first token and to authorize the entity. The non-transitory computer readable medium further contains instructions that when executed cause the at least one processor to generate a second token that includes the first token, where the second token is digitally signed using a private key of the specified service. In addition, the non-transitory computer readable medium contains instructions that when executed cause the at least one processor to initiate communication of the second token to a subsequent service in the series, where the subsequent service is configured to use a digital signature of the second token to identify the specified service as providing the second token and to authorize the specified service.

Any single one or any combination of the following features may be used with the third embodiment. The entity may include a preceding service in the series, the digital signature of the first token may be based on a private key of the preceding service, and a public key of the preceding service may be used to verify the digital signature of the first token. The first token may include an additional token provided to the preceding service. The first token may be received and processed without requesting that an external component verify an identity. The specified service may obtain public keys of other services and use one or more of the public keys to process tokens from the other services. The specified service may be configured with information identifying other services authorized to invoke the specified service, and the first token may be processed to determine whether a source of the first token is authorized to invoke the specified service based on the information. The first token may include an identifier of the second service as the first service's next hop in the series, and the second token may include an identifier of the subsequent service as the second service's next hop in the series. The second token may wrap all prior token or tokens generated by one or more preceding services in the series. A number of services in the series may be expandable to include any desired number of services. At least one of the first and second tokens may be associated with at least one authorized function and may not be used to invoke other functions. At least one of the first and second tokens may be associated with a defined time during which that token is valid.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting identification and authorization using wrapped tokens and public/private cryptographic keys according to this disclosure;

FIG. 2 illustrates an example device supporting identification and authorization using wrapped tokens and public/private cryptographic keys according to this disclosure;

FIGS. 3A through 3D illustrate an example signaling diagram supporting identification and authorization using wrapped tokens and public/private cryptographic keys according to this disclosure;

FIGS. 4A and 4B illustrate example tokens for use in identification and authorization according to this disclosure;

FIG. 5 illustrates an example functional architecture supporting identification and authorization using wrapped tokens and public/private cryptographic keys according to this disclosure; and

FIG. 6 illustrates an example method for identification and authorization using wrapped tokens and public/private cryptographic keys according to this disclosure.

### DETAILED DESCRIPTION

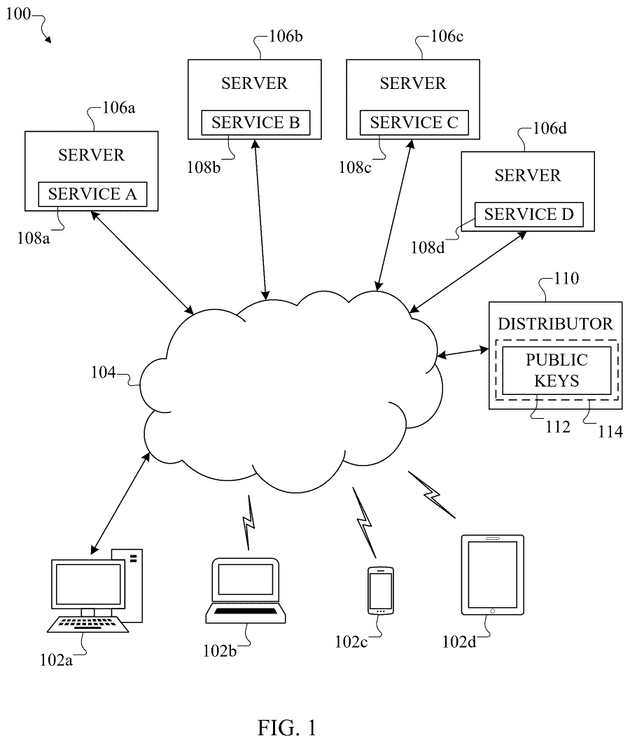

FIGS. 1 through 6, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, in conventional client-server architectures, it is a relatively simple task for a server to identify and authenticate a client or vice versa. Similarly, in other call chains involving only two entities, it is a relatively simple task for each entity to identify and authorize the other entity. Example techniques that may be used here include mutual Transport Layer Security (mTLS) techniques, bearer tokens, or digital signatures.

Unfortunately, when a call chain spans more than two entities, the above mechanisms generally become insufficient. For example, assume there is a series of micro-services or other services that can be chained together to provide one or more desired services to users. Here, each service in the chain of services may need to perform identification and authorization. As a particular example, in order for a user to invoke a function of service “D”, service “A” may need to identify and authorize the user, service “B” may need to identify and authorize service “A”, service “C” may need to identify and authorize services “A” and “B”, and service “D” may need to identify and authorize services “A”, “B”, and “C”.

With mTLS, each service typically has knowledge only of the preceding entity in the chain (either the preceding service or the user), and bearer tokens and digital signatures normally belong to a single entity. Passing the token of a leaf entity (such as the user's device) all the way through the call chain is effectively the same as intermediate entities impersonating the leaf entity. If each intermediate entity claims to act on behalf of all preceding entities but only submits its own token to a subsequent entity, the final entity in the chain is effectively trusting each intermediate entity. In all of these cases, the final entity is not verifying the identity and sequence of all prior entities in the call chain. As a result, none of these approaches may be desirable from a security perspective.

As a specific example of this, assume that a graphical user interface is provided by a website to view graph data in a ledger. This functionality could be served by a webserver running in a specified developer's project. The webserver may communicate with a production ledger to retrieve the graph data and render a webpage. If a user's device accesses the website, the ledger should serve data to which both the user and the specified developer have authorization. Otherwise, the user and the specified developer could obtain data that they are not entitled to obtain.

This disclosure provides techniques supporting identification and authorization using wrapped tokens and public/private cryptographic keys. As described in more detail below, each service in a series of services can receive a token associated with an entity, where that entity represents a user device or a preceding service in the series. A digital signature of the token can be used to identify the entity as providing the token and to authorize the entity. For each service other than the last service in the series, an additional token that wraps, embeds, or otherwise includes the received token can be generated, the additional token can be digitally signed using a private key of that service, and the additional token can be sent to a subsequent service in the series.

Each service in the series can use a digital signature of its received token to identify a preceding entity as providing the token and to authorize the preceding entity, and various services can use one or more digital signatures associated with one or more embedded tokens within its received token to identify one or more entities before the preceding service in the series. The last service in the series can receive a token that includes embedded tokens for all earlier entities in the series, and the last service in the series can therefore use its received token to identify the preceding service as providing the token and to authorize the preceding service and to verify all entities before the preceding service in the series. This allows the last service to confirm that the user and all intermediate entities (including all earlier services) have been identified and authorized. In this approach, each service can have its own unique public/private key pair, the public keys of the services can be verified and stored by a key distributor, and each service may obtain a public key needed to verify a digital signature of a received token from the key distributor.

In this way, each service in a series can verify the identity of a preceding service or other entity using the public key of the preceding entity and authorize the preceding entity using the token from the preceding entity. Each service in the series (except the last service) can also generate its own token on top of or embedding the token from the preceding entity, digitally sign its token, and send that token to a subsequent service in the series. This allows each subsequent service in the series to identify and verify all earlier entities in the series. The described techniques therefore provide a low-latency solution for delegated identification and authorization. Each service can identify and authorize a prior entity (such as a user or another service) using a token from that entity. Each service need not rely on requesting that a centralized authentication or authorization server (often referred to as a centralized witnesser or centralized witnesser service) perform the identification and authorization. Moreover, each service may not need to have knowledge of the entire call chain and may only need knowledge of the next service (if any) in the call chain, thereby providing flexibility and helping to ensure the abstraction of various services. In some cases, each token can be associated with one or more authorized functions (scopes), which can prevent an unauthorized party from using a token associated with one function to invoke another function. Additional functionality may also be supported, such as time limits on the validity of the tokens. Overall, the described techniques allow identification and authorization to occur along the entire call chain, improving overall security.

FIG. 1 illustrates an example system 100 supporting identification and authorization using wrapped tokens and public/private cryptographic keys according to this disclosure. As shown in FIG. 1, the system 100 includes multiple user devices 102a-102d, at least one network 104, multiple servers 106a-106d providing multiple services 108a-108d, and at least one key distributor 110. Note, however, that other combinations and arrangements of components may also be used here.

In this example, each user device 102a-102d is coupled to or communicates over the network(s) 104. Communications between each user device 102a-102d and at least one network 104 may occur in any suitable manner, such as via a wired or wireless connection. Each user device 102a-102d represents any suitable device or system used by at least one user to provide information to the servers 106a-106d or to receive information from the servers 106a-106d. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information, such as devices that can request execution of services 108a-108d on behalf of users and present results from the services 108a-108d.

The at least one network 104 facilitates communication between various components of the system 100. For example, the network(s) 104 may communicate Internet Protocol (IP) packets, frame relay frames, Asynchronous Transfer Mode (ATM) cells, or other suitable information between network addresses. The network(s) 104 may include one or more local area networks (LANs), metropolitan area networks (MANs), wide area networks (WANs), all or a portion of a global network such as the Internet, or any other communication system or systems at one or more locations. The network(s) 104 may also operate according to any appropriate communication protocol or protocols.

Each server 106a-106d is coupled to the at least one network 104 and is coupled to or otherwise communicates with the key distributor 110. Each server 106a-106d can provide at least one service 108a-108d, where each service 108a-108d represents one or more functions that can be executed upon user request or other request. As noted above, the services 108a-108d can often be arranged in one or more series (also referred to as call chains), where one service in the call chain can call another service in the call chain. This allows various combinations of services 108a-108d to be used to provide desired functionalities to the users. Each participant/service in a call chain can use the techniques described below to support identification and authorization of prior participant(s) in the call chain, such as by using tokens that are digitally signed. Each participant/service in the call chain can also be configured to know which other participants/services are authorized to invoke or call that participant/service and to reject requests from unauthorized participants/services.

Each key distributor 110 can be used to store public keys 112 associated with the services 108a-108d in the one or more call chains. For example, each service 108a-108d may generate a public/private key pair, and each service 108a-108d can send its public key 112 to the key distributor 110 for storage. Each service 108a-108d can also retrieve the public key 112 for another service 108a-108d from the key distributor 110. As described below, this allows the various services 108a-108d to obtain public keys 112 that can be used to perform one or more functions, such as verifying digital signatures of received tokens. Each key distributor 110 includes any suitable structure for storing and facilitating retrieval of public keys 112 and related information. In some embodiments, the public keys 112 may be stored in at least one data store 114 that is included in or accessible by the key distributor(s) 110. In some cases, each data store 114 may be referred to as a “spanner.”

Although FIG. 1 illustrates one example of a system 100 supporting identification and authorization using wrapped tokens and public/private cryptographic keys, various changes may be made to FIG. 1. For example, the system 100 may include any number of user devices 102a-102d, networks 104, servers 106a-106d, services 108a-108d, key distributors 110, public keys 112, and data stores 114. Also, various components in FIG. 1 may be combined, further subdivided, replicated, omitted, or rearranged and additional components or functions may be added according to particular needs. As a particular example, the same server 106a-106d could implement two or more of the services 108a-108d. Further, these components may be located in any suitable locations and might be distributed over a large area. In addition, while FIG. 1 illustrates one example operational environment in which identification and authorization using wrapped tokens and public/private cryptographic keys may be used, this functionality may be used in any other suitable system.

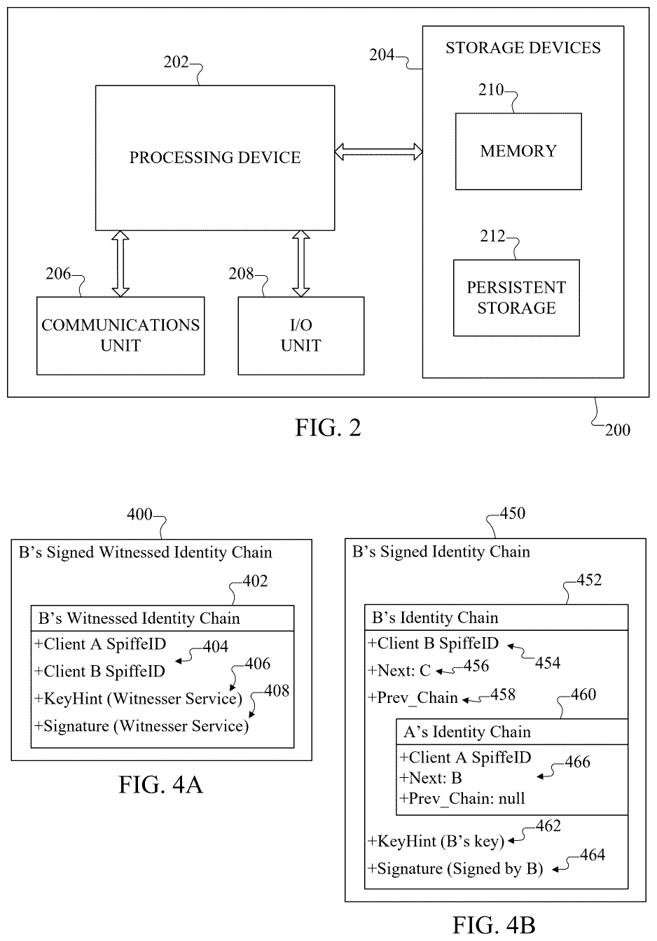

FIG. 2 illustrates an example device 200 supporting identification and authorization using wrapped tokens and public/private cryptographic keys according to this disclosure. In some embodiments, the device 200 shown in FIG. 2 may form at least part of a user device 102a-102d, server 106a-106d, or key distributor 110 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), graphics processing units (GPUs), neural processing units (NPUs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement or support the functions described below. Thus, for example, the instructions executed by the processing device 202 may cause the device 200 to exchange tokens with other devices and (using public keys from the key distributor 110) verify digital signatures and identify/authorize entities in one or more call chains.

Although FIG. 2 illustrates one example of a device 200 supporting identification and authorization using wrapped tokens and public/private cryptographic keys, various changes may be made to FIG. 2. For example, computing and communication devices and systems come in a wide variety of configurations, and FIG. 2 does not limit this disclosure to any particular computing or communication device or system. Also, various components in FIG. 2 may be combined, further subdivided, replicated, omitted, or rearranged and additional components or functions may be added according to particular needs.

The following now provides additional details of how identification and authorization may be performed using wrapped tokens and public/private cryptographic keys. Note that the details provided below are for illustration and explanation only and that various changes can be made to the described techniques. For example, while certain technologies or implementations (such as certain types of procedure calls, certificates, and tokens) may be described below, other technologies or implementations may be used.

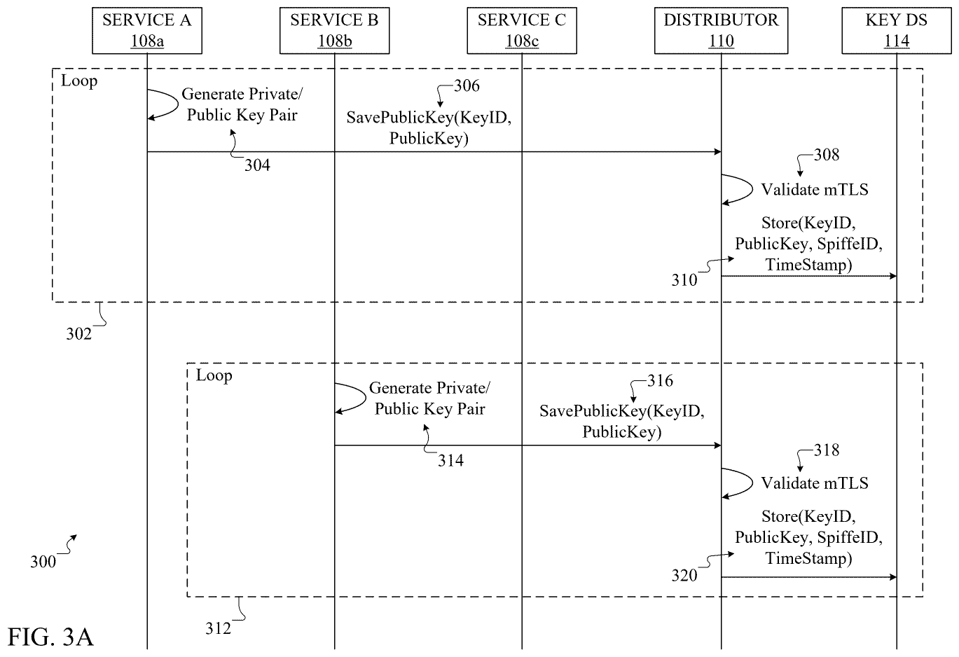

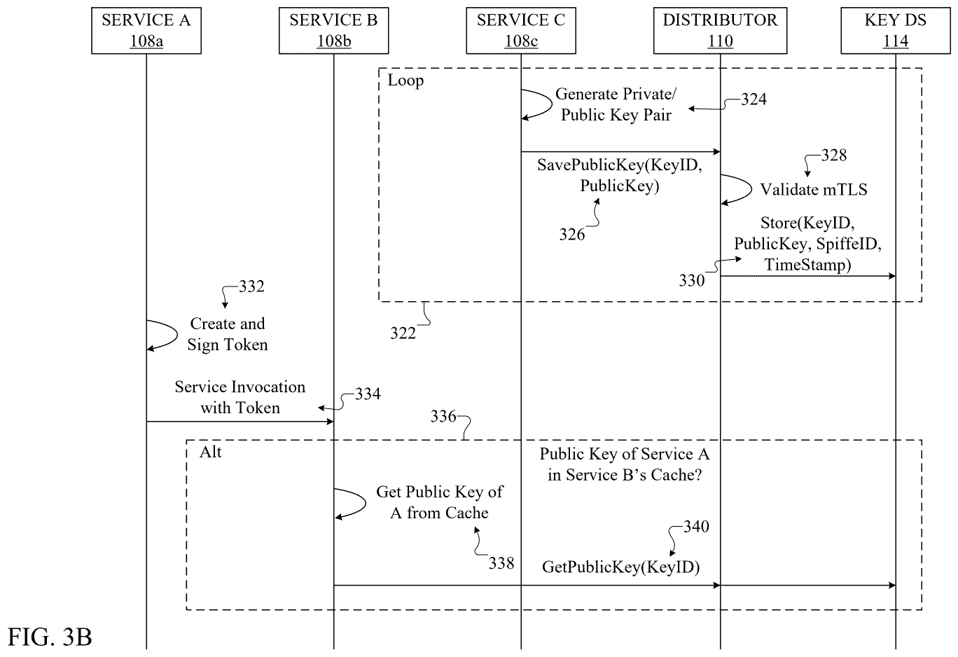

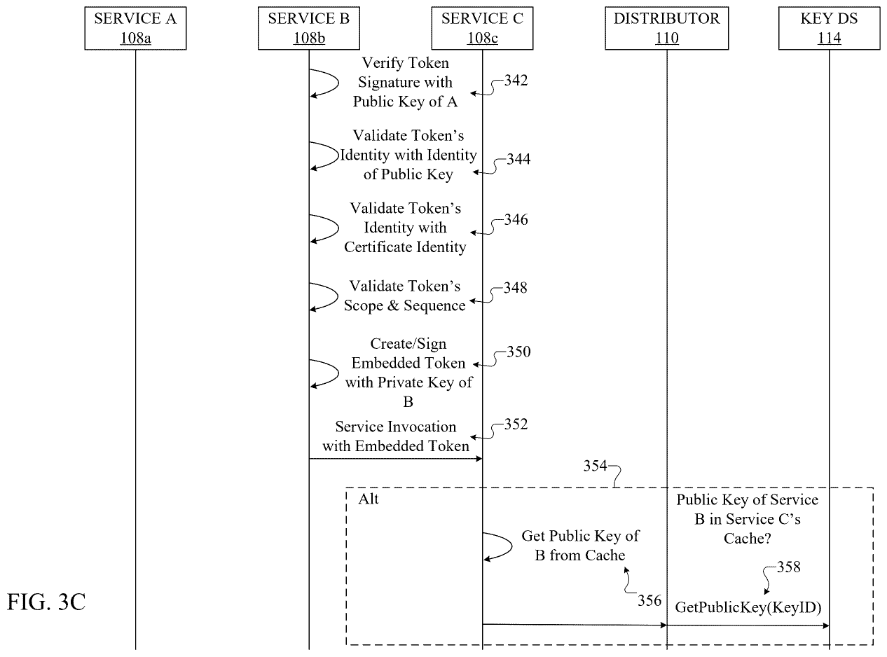

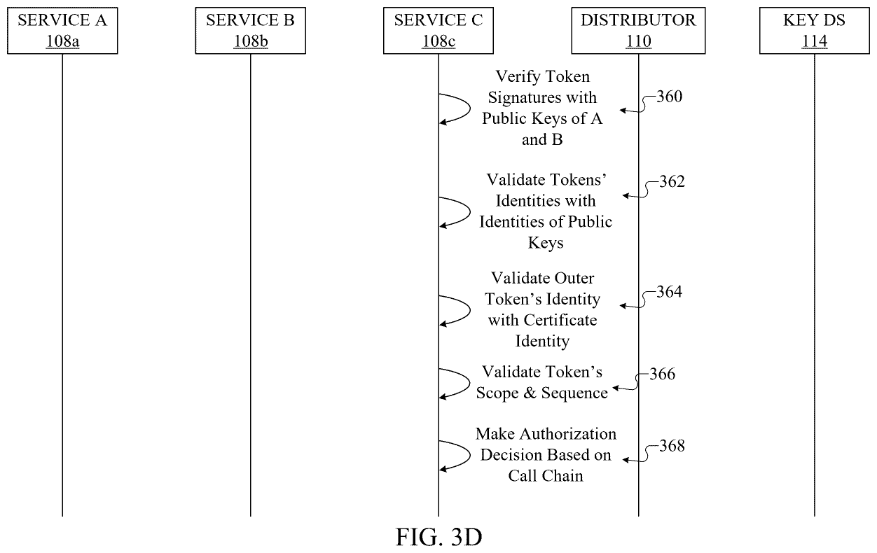

FIGS. 3A through 3D illustrate an example signaling diagram 300 supporting identification and authorization using wrapped tokens and public/private cryptographic keys according to this disclosure. For ease of explanation, the signaling diagram 300 shown in FIGS. 3A through 3D is described as being used in the system 100 of FIG. 1. However, the signaling diagram 300 may be used with any other suitable system, or the system 100 may use any other suitable signaling to implement the described processes. Note that in the following discussion, “self-signed” (which may also be referred to as “client signed”) indicates that an ID-chain bearer token or other token is signed by a participating entity, rather than a centralized witnesser service.

As shown in FIGS. 3A through 3D, the signaling diagram 300 generally involves three services 108a-108c, the at least one key distributor 110, and the at least one key data store (DS) 114. In this example, the key distributor(s) 110 and the key data store(s) 114 can implement or represent at least part of one or more centralized or other services that act as an authoritative store of all participants' public keys. However, note that the key distributor(s) 110 and the key data store(s) 114 here need not be involved in actually issuing or validating tokens. In some cases, each key distributor 110 can expose two methods, such as over gRPC or other remote procedure calls (RPCs), related to the public keys. One method can be used to store a public key, and another method can be used to fetch a public key.

As shown in FIG. 3A, with respect to the service 108a, the service 108a (as one participant in a call chain) can perform various operations as part of a loop 302. In some cases, the loop 302 can be performed at startup of the service 108a and at a specified interval (such as every N hours, where N has a value greater than zero) or at other times. As part of the loop 302, the service 108a can create its own asymmetric key, such as in the form of a public/private key pair, during operation 304. Any suitable technique(s) can be used here to generate an asymmetric key. The private key can be kept strictly in-memory or otherwise securely stored by or for the service 108a and might not be persisted anywhere else (including a local disk). The public key can be submitted to the key distributor(s) 110 for storage in the key data store(s) 114 during operation 306, such as by making an RPC over mTLS. In some embodiments, an RPC or other procedure call for storing a public key could include a public key identifier (“KeyID”) of the public key and the public key itself (“PublicKey”). Note that the public key identifier may also sometimes be referred to as a key hint (“KeyHint”).

Each key distributor 110 can authenticate the service 108a, such as by using mTLS, during operation 308 and store the public key in a data store 114 during operation 310. In some embodiments, a procedure call for storing a public key in a data store 114 could include the public key identifier or key hint (“KeyID” or “KeyHint”), the public key itself (“PublicKey”), an identity of the participant (the service 108a in this case) associated with the public key, and a timestamp or valid time (“TimeStamp”). In some cases, the public key may be stored along with information about the public key's identifier (such as in a column “KeyID” or “KeyHint” in the data store 114) and the participant's identity (such as in a column “Owner” in the data store 114). Also, in some cases, each participant's identity may be obtained in a secure manner, such as from a client certificate's Secure Production Identity Framework For Everyone (SPIFFE) Subject Alternative Name (SAN) of the participant, and need not be supplied explicitly as an argument by the service 108a.

As shown in FIG. 3A, with respect to the service 108b, the service 108b (as another participant in the call chain) can perform similar operations as part of a loop 312. Again, in some cases, the loop 312 can be performed at startup of the service 108b and at a specified interval (such as every N hours, where N has a value greater than zero) or at other times. As part of the loop 312, the service 108b can create its own asymmetric key, such as in the form of a public/private key pair, during operation 314. The public key can be submitted to the key distributor(s) 110 for storage in the key data store(s) 114 during operation 316. Each key distributor 110 can authenticate the service 108b during operation 318 and store the public key in a data store 114 during operation 320. The operations 314-320 here can be performed in the same or similar manner as the operations 304-310 described above.

As shown in FIG. 3B, with respect to the service 108c, the service 108c (as yet another participant in the call chain) can perform similar operations as part of a loop 322. Again, in some cases, the loop 322 can be performed at startup of the service 108c and at a specified interval (such as every N hours, where N has a value greater than zero) or at other times. As part of the loop 322, the service 108c can create its own asymmetric key, such as in the form of a public/private key pair, during operation 324. The public key can be submitted to the key distributor(s) 110 for storage in the key data store(s) 114 during operation 326. Each key distributor 110 can authenticate the service 108c during operation 328 and store the public key in a data store 114 during operation 330. The operations 324-330 here can be performed in the same or similar manner as the operations 304-320 described above. While not shown here, the same or similar operations may occur for the service 108d, any other services involved in one or more call chains, and/or one or more end user devices 102a-102d that provide requests to services.

Assume that the service 108a now wishes to invoke the service 108c as part of a call chain, such as in response to a request from a user. To invoke another service in the call chain, the service 108a can create a token and digitally sign the token with its own private key during operation 332. In some cases, the token can have information about the identity of the service 108a, possibly along with a valid time (Time To Live) and an identifier of the public key. The token could also optionally include or identify one or more authorized functions (a scope) associated with the token, which can be used to ensure that the token is not used for other functions. The token could further optionally include a “next service” identifier (also called a “next hop”) that identifies the service to which the token is being sent. The service 108a can make a service invocation call to the next participant (such as the service 108b) in the call chain and send the token during operation 334. In some cases, the call to the next participant may include the token as part of gRPC metadata (which could be equivalent to an HTTP header).

The receiving participant (the service 108b in this case) can perform one or more functions to obtain the public key of the preceding participant (the service 108a in this case) during operation 336. For example, the service 108b can determine whether the public key for the service 108a can be retrieved from a cache of or associated with the service 108b during operation 338. If not (or if no valid public key for the service 108a can be retrieved from the cache), the service 108b can request the public key for the service 108a from the key distributor 110 during operation 340. In some embodiments, a procedure call for retrieving a public key from a data store 114 could include the public key identifier or key hint (“KeyID” or “KeyHint”). Here, the key distributor 110 could authenticate the service 108b, retrieve the appropriate public key of the service 108a from the data store 114, and provide the retrieved public key of the service 108a to the service 108b.

As shown in FIG. 3C, once the public key of the preceding participant (the service 108a) is obtained, the service 108b can perform various validations. For example, the service 108b could verify the preceding participant (the service 108a), such as by using mTLS and verifying the digital signature of the token contained in or associated with the service invocation call from the service 108a using the public key of the service 108a, during operation 342. The service 108b could verify whether the claimed identity of the preceding participant's token (such as the SPIFFE URL of the service 108a) matches the identity of the entity associated with the public key of the service 108a during operation 344. The service 108b could verify whether the claimed identity of the preceding participant's token (such as the SPIFFE URL of the service 108a) matches the identity of the entity in a client certificate (such as the SPIFFE URL of the service 108a) during operation 346. Among other things, these validations help to ensure that compromised bearer tokens cannot be used without the client certificate and its private key. The service 108b could verify whether the received token has a valid scope and optionally defines a proper sequence of services during operation 348. For example, the service 108b could determine whether a scope associated with the token from the service 108a allows the function being invoked by the service 108a. The service 108b could also determine whether the token from the service 108a identifies the service 108b as the next service or hop. If the token from the service 108a embeds tokens from any prior service(s) in the call chain, the service 108b could verify the entire sequence of services up to that point, such as by verifying that the first service in the chain identified the second service as its next hop, the second service in the chain identified the third service as its next hop, and so on.

Assuming the validations are successful, the service 108b can determine that another service in the call chain (namely the service 108c) needs to be invoked. As a result, the service 108b can create its own token that embeds (wraps) the token from the service 108a, and the service 108b can digitally sign its token with its own private key during operation 350. In some cases, the new token can have information about the identity of the service 108b, possibly along with a valid time (Time To Live) and an identifier of the public key of the service 108b. Here, the token generated by the service 108b can include the token generated by the service 108a. In other words, the previous token from the preceding participant can be embedded or otherwise included in the new token. The service 108b can make a service invocation call to the next participant (such as the service 108c) and send its token during operation 352. In some cases, the call to the next participant may include the token as part of gRPC metadata.

The receiving participant (the service 108c in this case) can perform one or more functions to obtain the public key of the preceding participant (the service 108b in this case) during operation 354. For example, the service 108c can determine whether the public key for the service 108b can be retrieved from a cache of or associated with the service 108c during operation 356. If not (or if no valid public key for the service 108b can be retrieved from the cache), the service 108c can request the public key for the service 108b from the key distributor 110 during operation 358. In some embodiments, a procedure call for retrieving a public key from a data store 114 could include the public key identifier or key hint (“KeyID” or “KeyHint”). Here, the key distributor 110 could authenticate the service 108c, retrieve the appropriate public key of the service 108b from the data store 114, and provide the retrieved public key of the service 108b to the service 108c.

As shown in FIG. 3D, once the public key of the preceding participant (the service 108b) is obtained, the service 108c can perform various validations. For example, the service 108c could perform validations 360-366, which may occur in the same or similar manner as the validations 342-348 discussed above. However, in this case, the service 108c can validate both (i) the “outer” token of the service 108b and (ii) the “inner” token of the service 108a that is embedded within the token of the service 108b. Also, during the validation 366, the service 108c can ensure that (i) the inner token of the service 108a identifies the service 108b as its next hop and (ii) the outer token of the service 108b identifies the service 108c as its next hop. Assuming the validations are successful, the service 108c can determine whether the requests from the services 108a-108b can be fulfilled, such as by determining whether the service 108c is permitted to execute one or more functions for the services 108a-108b, as part of an authorization decision 368. As can be seen here, the service 108c is able to validate the entire call chain from the service 108a to the service 108c, rather than just validating a single entity in the call chain (such as the previous entity).

As noted above, in some cases, each participant in a call chain can rotate its keys and register its new public key with the key distributor(s) 110 periodically or at other times, such as by using the sequence of operations 304-310/314-320/324-330 described above. Thus, in terms of performance characteristics, each participant can store its public key in a key data store 114 whenever the participant generates a new public key/private key pair. In some cases, this may involve mTLS validation, network latency, and a transaction involving the data store 114. This cost may be incurred once at startup and periodically or at other times later, such as once every N hours. However, in some cases, the updates to provide key rotations may occur in a background thread and may not significantly impact the latency budget of ongoing requests and responses. Also, since each participant here can generate new tokens that are self-signed, there may be no network calls involved in minting new tokens. Digital signing can be a completely CPU-bound operation and can have a fixed cost that does not vary with the call chain length, meaning it is an O(1) operation. To validate incoming tokens, each participant in a call chain may include a cache of public keys that the participant has already seen. If there is a cache miss, the participant can fetch the public key from the key distributor(s) 110. In the worst case, this is an O(M) operation, where Mis the call chain length. However, this cost may be amortized across all requests from the same participant until the participant's keys are rotated. With a public key, the validation of tokens can be completely local with no further network calls, meaning it is a CPU-bound operation. For each participant of a call chain, the number of validations can be dependent on the call chain length, meaning it is an O(M) operation. However, eliminating network latency and the standard centralized witnesser service's overhead can help to compensate for this overhead.

This type of approach can be used with any number of services and other participants in one or more call chains. Each participant can register its public key with the key distributor(s) 110 one or more times, and each participant can request the public key(s) of other participant(s) from the key distributor(s) 110. In a chain of participants, each participant other than the last participant in the chain can provide a token to a subsequent participant in the chain. One or more participants in the chain can also embed a token from at least one previous participant into its own token and send the combined token to a subsequent participant. This enables the final participant in the chain to identify each previous participant in the chain and validate those participants to confirm whether the original request for service from the first entity can be provided.

Although FIGS. 3A through 3D illustrate one example of a signaling diagram 300 supporting identification and authorization using wrapped tokens and public/private cryptographic keys, various changes may be made to FIGS. 3A through 3D. For example, a call chain could include any suitable number of services, such as four or more services. Also, the specific messages and message contents shown here are examples only and could vary depending on the implementation.

FIGS. 4A and 4B illustrate example tokens 400, 450 for use in identification and authorization according to this disclosure. More specifically, FIG. 4A illustrates an example token 400 that could be generated using a standard approach, and FIG. 4B illustrates an example token 450 that could be generated using the technique of this disclosure.

As shown in FIG. 4A, the token 400 is associated with a service (namely the service 108b in this example) and takes the form of a signed witnessed identity chain. Here, the signed witnessed identity chain includes a witnessed identity chain 402. The witnessed identity chain 402 includes the SPIFFE identifier(s) 404 for the current service and any earlier service(s) in the call chain (namely the service 108a in this example). The token 400 also includes a key hint 406 and a digital signature 408. The key hint 406 can be used to identify a cryptographic key to be used by a centralized witnesser service, and the digital signature 408 can be generated by the centralized witnesser service. As can be seen here, a recipient of the token 400 cannot verify that all prior services in the call chain are identified and authorized since, for example, there is no token or digital signature of the service 108a.

As shown in FIG. 4B, the token 450 can be generated by a service (namely the service 108b in this example) and takes the form of a signed identity chain. The signed identity chain includes an identity chain 452 having the SPIFFE identifier 454 for the current service. The identity chain 452 may also optionally include a next service identifier 456, which can identify the subsequent service to be invoked in the call chain by the service 108c (namely the service 108c in this example). If there is no additional service to be invoked, the next service identifier 456 could have a null value or other suitable indicator.

Rather than merely including the SPIFFE identifier for any earlier service in the call chain, the token 450 can include a previous chain sequence 458, which may (if there is at least one earlier service in the call chain) include an embedded token 460 in the form of a signed identity chain from the preceding service in the call chain. The embedded token 460 represents the token obtained by the service 108b from the preceding service 108a in the call chain. The token 450 further includes a key hint 462 and a digital signature 464. The key hint 462 can be used to identify a public key associated with the service 108b, and the digital signature 464 can be generated by the service 108b (without the need for a centralized witnesser service).

In this example, the embedded token 460 can include contents 466 similar to the token 450. For example, the embedded token 460 can include a SPIFFE identifier for the previous participant in the call chain, an identification of the subsequent participant in the call chain (namely the service 108b in this example), and (if appropriate) a previous chain sequence for an earlier participant in the call chain. If there was an earlier participant in the call chain, the previous chain sequence in the embedded token 460 could itself include an embedded token from the earlier participant.

In this way, the token 450 can be used to capture any previous tokens for participants in a call chain, and the next service (such as the service 108d) that receives the token 450 is able to use the token 450 (including all embedded tokens 460) to identify and validate all prior participant(s) in the call chain. In other words, each token 450 can embed the token(s) of the prior participant(s) in the call chain, allowing a subsequent service (such as the service 108d) to identify and verify all prior participants. For example, the service 108d can use the next service identifiers 456 in all of the received tokens to ensure that the service 108d receives tokens from the appropriate prior services in the call chain and that those prior services were positioned in the call chain in the correct order as defined by the next service identifiers 456. Effectively, the tokens 450 generated by the series of services can be serialized so that each token (except an initial token) wraps or embeds all prior token(s) in the call chain. This can be achieved without requiring any service to use a centralized witnesser service to authorize the prior participants. Instead, each service can use the public key(s) of the prior participant(s) to validate the token/embedded token(s) received from an earlier service.

In some cases, identities in a call chain cannot be reordered. For example, in the context of the services 108a-108d, embedded tokens may ensure that the service 108c cannot reorder the call sequence, meaning the service 108c cannot create a token that says the sequence order is service 108b, service 108a, and service 108c (rather than service 108a, service 108b, and service 108c). Here, each token could identify the next hop in the call chain, and no service in the call chain could modify the ordering without creating a signature mismatch and rejection of a token from a service attempting to modify the ordering.

Also, in some cases, identities in a call chain cannot be truncated. For example, in the context of the services 108a-108d, the service 108c cannot drop the service 108b and generate a token that says the sequence order is service 108a and service 108c (since the token from the service 108a identifies the service 108b as its next hop). In some embodiments, this can be achieved by using the next service identifier 456 in each token. For instance, each token signed by the service 108a may indicate that the next authority is the service 108b, each token signed by the service 108b may indicate that the next authority is the service 108c, etc. This can be useful because the service 108d might want to enforce an authorization policy that involves the most restrictive access among all participants in the call chain or deny certain actions if any participants is non-change controlled.

Further, in some cases, compromised tokens cannot be used. For example, each participant in a call chain could have a public/private key pair as described above. In some embodiments, each participant's public key can be used to create a signed certificate, such as one where the certificate's SAN has a SPIFFE-based identifier of the participant. The participant that generates a token can embed its identity using the SPIFFE notation via its SPIFFE identifier 454. This token is sent to the next participant in the call chain, such as over a channel protected with mTLS. One of the verifications that the receiving participant can perform is to confirm that the SPIFFE identity in the token matches the SPIFFE identity in the client certificate of the sending participant. Thus, a token may only be used if the sending participant has access to the correct private key. A compromised token (such as one accidentally logged or captured by an intermediate party) cannot be used because the intermediate party does not have access to the private key of the sending participant that signed the token.

In addition, in some cases, scopes can be enforced using the tokens. For example, the service 108a might have permissions to perform various functions, such as making payments, settling a trade, booking a trade, cancelling a trade, etc. When the service 108a generates a token and sends the token to the service 108b, the intention may be that the service 108b will use the token to book a trade in the service 108c. However, if the service 108b is compromised, the service 108b could use that token and attempt to make a payment in a different system. To avoid this, the service 108a may stamp one or more scopes (such as “TRADE-BOOKING”, “TRADE-CANCELLATION”, etc.) on the token. All participants can be aware of the concept of scopes and well-defined scope values. If a token with scope X is used as part of a request to perform function Y, the receiving participant can reject the token. This approach thereby provides a mechanism to attenuate each token's permissions to a subset of a participant's ambient capabilities. Similarly, the next service identifiers 456 allow sequences of tokens to essentially embed or identify an order of services to be invoked in a call chain. If a token with embedded tokens is received and the ordering of the services is not correct as defined by the next service identifiers 456, the receiving participant can reject the token.

In some embodiments, each token 450 may represent a protobuf-encoded or other encoded payload. As noted above, if there are multiple participants in a call chain, each token 450 can embed or otherwise include the token for each previous participant. The following represents one example of code that could be used to implement a token structure of the token 450 shown in FIG. 4B. However, it should be noted that any other suitable code may be used to implement the token structure shown in FIG. 4B or another token structure that embeds one or more tokens from one or more prior participants in a call chain.

// This attests to the logical identity of the attestor
message Attestation {
// This is simply a GUID so we can track this attestation through time
string attestation_id = 1 [symbol]
// This is the service that attests to having seen the identity
ClientSpiffeId attested_by_client = 2 [symbol]
// Scopes in which this identity may be used repeated
AuthorizationScope scope = 3 [symbol]
// Invalid after this time
google.protobuf.Timestamp
expiry = 4 [symbol]
}
// Each Client extends its own attestation and the next gRPC callee to the previous signed
// ClientWitessedIdentityChain
message ClientWitnessedIdentityChain {
ClientSignedWitnessedIdentityChain prev_client_signed_chain = 3 [symbol] // token from the
// last caller
}
// Each client uses its own key sign the above ClientWitnessedIdentityChain [symbol] then passes //
it to the next gRPC caller in the header.
message ClientSignedWitnessedIdentityChain {
string key_hint = 1 [symbol]
bytes signature = 2 [symbol]
bytes client_witnessed_identity_chain = 3 [symbol] // map to ClientWitnessedIdentityChain
}
// Simply the raw spiffe id string, usually extracted from the Subject Alternative Name of
// the x509 c [symbol] presented to the Witnesser service in the mTLS handshake message
ClientSpiffeId {

[symbol]

[symbol]

indicates data missing or illegible when filed

Although FIGS. 4A and 4B illustrate examples of tokens 400, 450 for use in identification and authorization, various changes may be made to FIGS. 4A and 4B. For example, the specific contents of the token 450 shown in FIG. 4B are for illustration and explanation only and could vary depending on the implementation, such as when identifiers other than SPIFFE identifiers are used.

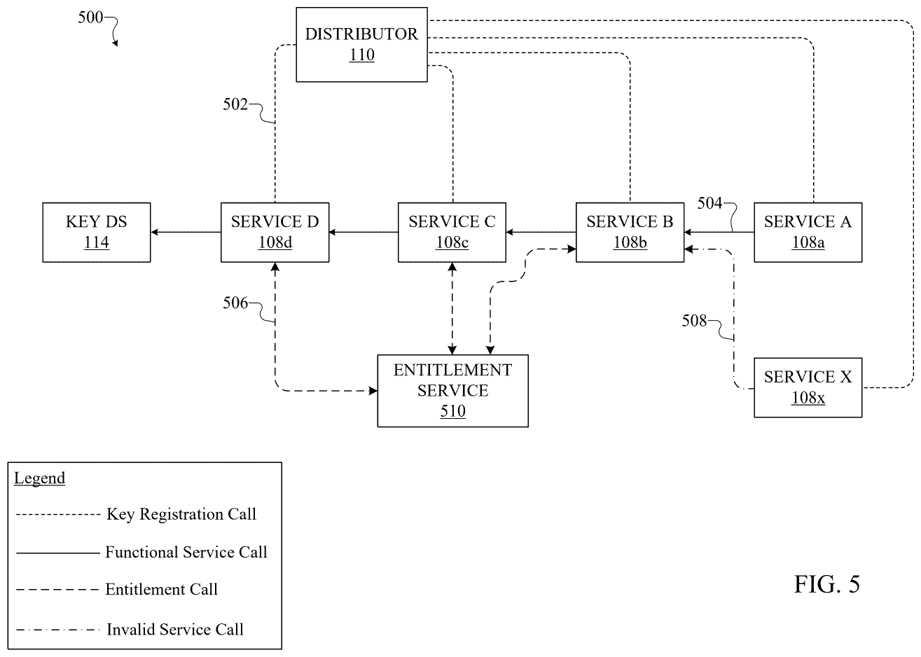

FIG. 5 illustrates an example functional architecture 500 supporting identification and authorization using wrapped tokens and public/private cryptographic keys according to this disclosure. More specifically, FIG. 5 illustrates an example architecture 500 in which the services 108a-108d can be used to identify and authorize one another as part of a call chain. For ease of explanation, the architecture 500 shown in FIG. 5 is described as being implemented in the system 100 of FIG. 1. However, the architecture 500 may be used with any other suitable system, or the system 100 may use any other suitable functional architecture (such as one supporting any number of services in any number of call chains) to implement the described processes.

As shown in FIG. 5, each service 108a-108d (along with an additional service 108x) can generate its own public/private cryptographic key pair and can make a key registration call 502 to register its public key with a key distributor 110. The key distributor 110 can store the public keys in a key data store 114. As noted above, each service 108a-108d, 108x could make a key registration call 502 after generating a key pair at startup and at other times, such as when needed or periodically (like every N hours). Each service 108a-108d, 108x can also have the ability to retrieve public keys from the key data store 114 and to store the retrieved public keys locally, such as in a local cache. In some cases, each retrieved public key could have a valid time (such as a Time To Live or TTL value) identifying the period when the public key is valid.

The services 108a-108d can also interact with one another and make functional (valid) service calls 504 within a specified call chain. For example, the service 108a can generate its own token 450 using its own private key and pass its token 450 to the service 108b using a service call 504. The service 108b can validate the identity of the service 108a using the token 450 from the service 108a. The service 108b can also determine that the service 108a is permitted to request a specified service, such as based on information obtained from an entitlement service 510, like an Open standards-based Cloud Entitlements Service (OCES), in response to an entitlement call 506. Assuming the service 108a is permitted to request a specified service, the service 108b can generate its own token 450 using its own private key and embedding the token 450 from the service 108a, and the service 108b can pass its token 450 to the service 108c using another service call 504.

The service 108c can validate the identities of both services 108a-108b using the token 450 from the service 108b (which embeds the token 450 from the service 108a). The service 108c can also determine that the service 108b (and optionally the service 108a) is permitted to request a specified service, such as based on information obtained from the entitlement service 510 in response to another entitlement call 506. Assuming service invocation is permitted, the service 108c can generate its own token 450 using its own private key and embedding the tokens 450 from the services 108a-108b, and the service 108c can pass its token 450 to the service 108d using yet another service call 504.

The service 108d can validate the identities of all prior services 108a-108c using the token 450 from the service 108c (which embeds the tokens 450 from the services 108a-108b). The service 108d can also determine that the service 108c (and optionally the services 108a-108b) is permitted to request a specified service, such as based on information obtained from the entitlement service 510 in response to yet another entitlement call 506. Assuming service invocation is permitted, the service 108d can execute one or more functions on behalf of the prior service(s) 108a-108c in the call chain. In some cases, the services 108a-108d can operate as a chain of functions in which the result(s) of one or more functions performed by one service can be provided to and used by one or more functions performed by another service in the call chain.

FIG. 5 also illustrates an invalid service call 508, which is provided by the service 108x to the service 108b in this example. Here, the service 108x is attempting to invoke the service 108b improperly, and the service 108b can therefore reject the invalid service call 508 from the service 108x. A determination of whether a service call is valid or invalid may occur in any suitable manner. In some embodiments, for instance, the service 108b may be configured with information, such as a list of known or authorized services, identifying which services can invoke the service 108b. In some cases, the service 108b may be configured with this information at build-time of the service 108b. In other embodiments, the service 108b may determine that the service 108x cannot invoke the service 108b based on an entitlement call 506 to the entitlement service 510. Note that the same types of functions could be performed by any of the services 108a-108d, thereby helping to avoid unauthorized invocation of any service 108a-108d by the service 108x.

Although FIG. 5 illustrates one example of a functional architecture 500 supporting identification and authorization using wrapped tokens and public/private cryptographic keys, various changes may be made to FIG. 5. For example, various components or functions in FIG. 5 may be combined, further subdivided, replicated, omitted, or rearranged and additional components or functions may be added according to particular needs. Also, the functional architecture 500 could include any suitable number of services within any suitable number of call chains. In general, the described techniques allow for the number of services in a call chain to be expandable in order to include any desired number of services and for the number of call chains to be expandable.

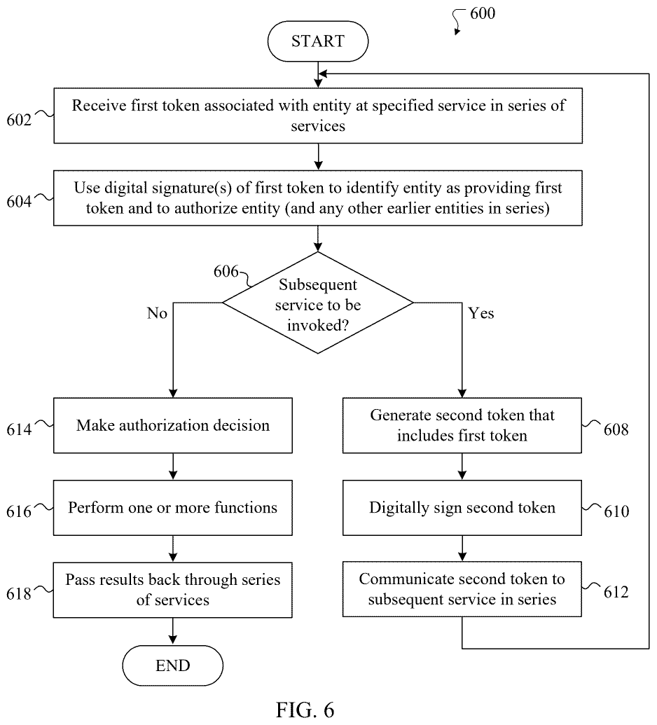

FIG. 6 illustrates an example method 600 for identification and authorization using wrapped tokens and public/private cryptographic keys according to this disclosure. For ease of explanation, the method 600 shown in FIG. 6 is described as being implemented in the system 100 of FIG. 1. However, the method 600 may be performed using any other suitable system.

As shown in FIG. 6, a first token associated with an entity is received at a specified service in a series of services at step 602. This may include, for example, the processing device 202 of the server 106b that executes the service 108b receiving a token 450 from a preceding service 108a in a call chain, where the token 450 can be signed using a private key of the preceding service 108a. Here, the digital signature of the first token can be based on the private key of the preceding service 108a.

A digital signature of the first token is used to identify the entity as providing the first token and to authorize the entity at step 604. This may include, for example, the processing device 202 of the server 106b that executes the service 108b using a public key of the service 108a to verify that the token 450 was signed using the private key of the service 108a. If the service 108a is not the first entity in the call chain, this may also include the processing device 202 of the server 106b that executes the service 108b using a public key of any other preceding participant in the call chain to verify that an additional token embedded within the token 450 was signed using the private key of the preceding participant. In some cases, the service 108b could obtain each public key of a prior participant in the call chain in order to process the received token, such as by obtaining a public key from a cache associated with the service 108b or by requesting a public key from a data store 114 via a key distributor 110. This allows the service 108b to receive and process the first token without requesting that an external component (such as a central witnesser service) verify an identity of the service 108a or other prior participant. This may further include the processing device 202 of the server 106b that executes the service 108b performing one or more additional validations to ensure that the service 108a (and possibly any preceding participant) is permitted to invoke the service 108b or a subsequent service in the call chain. For instance, the service 108b may be configured with information identifying other services authorized to invoke the service 108b, and the service 108b can process the received token 450 by determining whether a source of the received token 450 is authorized to invoke the service 108b based on the information. As other examples, the first token 450 may be associated with at least one authorized function and the service 108b could ensure that the prior service 108a is not attempting to invoke other functions, and/or the first token 450 may be associated with a defined time during which the token 450 is valid and the service 108b could ensure that the prior service 108a is not attempting to invoke the service 108b using an expired token 450.

A determination is made whether a subsequent service in the call chain is to be invoked at step 606. This may include, for example, the processing device 202 of the server 106b that executes the service 108b determining whether a subsequent service 108c in the call chain should be invoked. If there is a subsequent service to be called, a second token is generated at step 608 and digitally signed at step 610. This may include, for example, the processing device 202 of the server 106b that executes the service 108b generating a second token 450 that includes or embeds the first token 450 received by the service 108b from the preceding service 108a. This may also include the processing device 202 of the server 106b that executes the service 108b digitally signing the second token 450 using the private key of the service 108b. The second token is communicated to the subsequent service in the series at step 612. This may include, for example, the processing device 202 of the server 106b that executes the service 108b initiating communication of the second token 450 to the server 106c that is executing the service 108c. The process can return to step 602, where the subsequent service 108c in the call chain can receive and process the token from the service 108b as its first token.

This process can continue by repeating steps 602-612 until a final service in the call chain (such as the service 108d) receives a token that embeds or wraps all prior token(s) in the series. At that point, the final service 108d in the call chain can determine at step 606 that no additional services are to be called. The final service in the call chain can make an authorization decision at step 614. This may include, for example, the processing device 202 of the server 106d that executes the service 108d verifying that all prior services 108a-108c in the call chain are authorized to invoke the service 108d. This may also include the processing device 202 of the server 106d that executes the service 108d verifying that an order of the services in the call chain matches an order of services as defined by the next service identifiers 456 of the received token and its embedded tokens. Other or additional verifications could also be performed as described above.

If the authorization decision is positive, one or more functions of the service are performed at step 616, and one or more results can be passed back through the series of services at step 618. This may include, for example, the processing device 202 of the server 106d executing one or more functions of the service 108d and providing one or more results back to the service 108c. This may also include the processing device 202 of the server 106c executing one or more functions of the service 108c (possibly based on the one or more results from the service 108d) and providing one or more results back to the service 108b. This can continue until one or more results from the series of services are provided to a requesting entity or used in some manner.

Although FIG. 6 illustrates one example of a method 600 for identification and authorization using wrapped tokens and public/private cryptographic keys, various changes may be made to FIG. 6. For example, while shown as a series of steps, various steps in FIG. 6 could overlap, occur in parallel, occur in a different order, or occur any number of times (including zero times). Also, while the description above may assume that each service 108a-108d is implemented using a different server 106a-106d, this need not be the case, and at least some of the services could be implemented using the same server(s).

It should be noted that the functions shown in the figures or described above can be implemented in one or more servers 106a-106d, user devices 102a-102d, or other device(s) in any suitable manner. For example, in some embodiments, at least some of the functions shown in the figures or described above can be implemented or supported using one or more software applications or other software instructions that are executed by at least one processing device 202 of the server(s) 106a-106d, user device(s) 102a-102d, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed using any suitable number of devices.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A method comprising:
receiving, by a specified service in a series of services, a first token associated with an entity;
using a digital signature of the first token to identify the entity as providing the first token and to authorize the entity;
generating a second token that includes the first token, the second token digitally signed using a private key of the specified service; and
communicating the second token to a subsequent service in the series, the subsequent service configured to use a digital signature of the second token to identify the specified service as providing the second token and to authorize the specified service;
wherein tokens associated with the series, including the first and second tokens, are serialized such that each token except an initial token wraps all prior token or tokens in the series.

2. The method of claim 1, wherein:
the entity comprises a preceding service in the series;
the digital signature of the first token is based on a private key of the preceding service; and
a public key of the preceding service is used to verify the digital signature of the first token.

3. The method of claim 2, wherein the first token includes an additional token provided to the preceding service.

4. The method of claim 1, wherein each service in the series receives and processes a respective token without requesting that an external component verify an identity.

5. The method of claim 4, wherein each service in the series obtains public keys of other services and uses one or more of the public keys to process the respective token.

6. The method of claim 1, wherein:
each service in the series is configured with information identifying other services authorized to invoke that service; and
each service in the series processes a respective token by determining whether a source of the respective token is authorized to invoke that service based on the information.

7. The method of claim 1, wherein:
the first token includes an identifier of a second service as a first service's next hop in the series; and
the second token includes an identifier of the subsequent service as the second service's next hop in the series.

8. (canceled)

9. The method of claim 1, wherein a number of services in the series is expandable to include any desired number of services.

10. The method of claim 1, wherein each token is associated with at least one authorized function and cannot be used to invoke other functions.

11. The method of claim 1, wherein each token is associated with a defined time during which the token is valid.

12. An apparatus comprising:
at least one processing device configured to:
receive, for a specified service in a series of services, a first token associated with an entity;
use a digital signature of the first token to identify the entity as providing the first token and to authorize the entity;
generate a second token that includes the first token, the second token digitally signed using a private key of the specified service; and
initiate communication of the second token to a subsequent service in the series, the subsequent service configured to use a digital signature of the second token to identify the specified service as providing the second token and to authorize the specified service;
wherein the second token wraps all prior token or tokens generated by one or more preceding services in the series.

13. The apparatus of claim 12, wherein:
the entity comprises a preceding service in the series;
the digital signature of the first token is based on a private key of the preceding service; and
the at least one processing device is configured to use a public key of the preceding service to verify the digital signature of the first token.

14. The apparatus of claim 13, wherein the first token includes an additional token provided to the preceding service.

15. The apparatus of claim 12, wherein the at least one processing device is configured to receive and process the first token without requesting that an external component verify an identity.

16. The apparatus of claim 12, wherein:
the specified service is configured with information identifying other services authorized to invoke the specified service; and
the at least one processing device is configured to process the first token and determine whether a source of the first token is authorized to invoke the specified service based on the information.

17. The apparatus of claim 12, wherein:
the first token includes an identifier of a second service as a first service's next hop in the series; and
the second token includes an identifier of the subsequent service as the second service's next hop in the series.

18. (canceled)

19. The apparatus of claim 12, wherein at least one of:
at least one of the first and second tokens is associated with at least one authorized function and cannot be used to invoke other functions; or
at least one of the first and second tokens is associated with a defined time during which that token is valid.

20. A non-transitory computer readable medium containing instructions that when executed cause at least one processor to:
receive, for a specified service in a series of services, a first token associated with an entity;
use a digital signature of the first token to identify the entity as providing the first token and to authorize the entity;
generate a second token that includes the first token, the second token digitally signed using a private key of the specified service; and
initiate communication of the second token to a subsequent service in the series, the subsequent service configured to use a digital signature of the second token to identify the specified service as providing the second token and to authorize the specified service;
wherein the second token wraps all prior token or tokens generated by one or more preceding services in the series.

21. The method of claim 2, wherein:
the preceding service generates the public key and the private key; and
the public key is retrieved from a key distributor that is configured to store public keys prior to being used to verify the digital signature of the first token.

22. The method of claim 7, further comprising:
verifying that an order of the services in the series matches an order of services as defined by the first token's identifier and the second token's identifier.
